(19) United States
(12) Patent Application Publication
(10) Pub. No.: US 2025/0222987 A1
(43) Pub. Date: Jul. 10, 2025

(54) Luggage Compartment Floor for a Motor Vehicle

(71) Applicant: Bayerische Motoren Werke Aktiengesellschaft, Muenchen (DE)

(72) Inventors: Johannes PAULI, Muenchen (DE); Manuel RIEDL, Weil (DE); Felix SCHUMACHER, Muenchen (DE)

(21) Appl. No.: 18/852,601

(22) PCT Filed: May 25, 2023
(86) PCT No.: PCT/EP2023/064068

§ 371 Date: Sep. 30, 2024

(30) Foreign Application Priority Data
Jun. 8, 2022 (DE) 10 2022 114 342.2

(51) Int. Cl. B62D 25/08

(52) U.S. Cl. CPC B62D 25/087

(57) ABSTRACT

(EN) The invention relates to a luggage compartment floor for a motor vehicle, the floor having a bulge, wherein part of at least one sidewall of the bulge is corrugated.

The present invention relates to a luggage compartment floor for a motor vehicle, having the features of the preamble of patent claim 1.

Luggage compartment floors for motor vehicles in various design embodiments are known from the prior art. These luggage compartment floors are provided for closing an opening which is formed in a rear region of the motor vehicle, and typically have a planar shape.

Known from DE 100 09 508 B4 is a case-type container for placing in a motor vehicle trunk, wherein one or a plurality of side walls of the container is/are shaped so as to be adapted to the shape of the walls of the vehicle trunk adjacent to which the side walls of the container come to lie within the transport space.

DE 100 38 604 A1 describes an insert part for a luggage compartment of a motor vehicle, which in the resting position bears on a vehicle floor and therein is located within the contour of the latter, while the insert part is pivoted about a pivot axis to achieve an operative position.

Due to current developments in the automotive sector, there is an increase in the required installation space in rear regions of motor vehicles, in particular below the luggage compartment floor.

It is an object of the present invention to propose a luggage compartment floor for a motor vehicle, which provides a large installation space in a region that is covered by the luggage compartment floor in the assembled state, and at the same time meets stiffness requirements that are specific to the motor vehicle.

This object is achieved according to the invention by the luggage compartment floor having the features of patent claim 1.

According to the invention, a luggage compartment floor is thus provided, in particular a front luggage compartment floor, for a motor vehicle, which luggage compartment floor comprises a convexity. The convexity comprises at least one side wall which at least in part, in particular in a horizontal section through the at least one side wall, has a wave shape.

It is thus a core concept of the invention to provide the luggage compartment floor with a convexity, as a result of which more installation space is provided below the luggage compartment floor. Moreover, it is a core concept of the invention to design at least one side wall of the convexity so as to be at least in part wave-shaped in order to meet stiffness requirements that are specific to the motor vehicle.

The luggage compartment floor is made of steel, for example.

The convexity can define a cavity which has the shape of a truncated pyramid having a rectangular or a square base area, or the shape of a rectangle or of a square.

In one preferred embodiment of the luggage compartment floor according to the invention, the side walls, in particular at their lower ends in the luggage compartment floor vertical direction, are in each case contiguous to a base area.

The luggage compartment tub is able to be attached to a body of a motor vehicle for example, in particular to a luggage compartment tub frame of the body, by way of the base area.

The base area extends horizontally, for example.

In one preferred embodiment of the luggage compartment floor according to the invention, the convexity comprises a floor element. The side walls, in particular at their upper ends in the luggage compartment floor vertical direction, are contiguous to the floor element.

In an installed state of the luggage compartment floor according to the intended function in a motor vehicle, the luggage compartment floor longitudinal direction corresponds to the motor vehicle longitudinal direction; the luggage compartment floor transverse direction corresponds to the motor vehicle transverse direction; and the luggage compartment floor vertical direction corresponds to the motor vehicle vertical direction.

The floor element can extend horizontally, i.e. in the luggage compartment floor longitudinal direction and the luggage compartment floor transverse direction.

The floor element extends parallel to the base area, for example.

The base area is disposed below the floor element in the luggage compartment floor vertical direction, for example.

The wave shape is, for example, a continuous wave shape, i.e. free of edges

The wave shape can be a sinusoidal wave shape.

The wave shape is, for example, a longitudinal wave shape, i.e. the waves of the wave shape oscillate in the side wall transverse direction, whereby the oscillation extends in the side wall longitudinal direction, or the wave crests and wave troughs of the wave shape extend in the side wall vertical direction, respectively. The wavelength is thus the length of the waves of the wave shape in the side wall longitudinal direction, and the amplitude of the waves of the wave shape is the extent of the waves in the side wall transverse direction.

The side wall longitudinal direction corresponds to the direction of longitudinal extent of the respective side wall.

The side wall longitudinal direction runs horizontally, for example.

If the side wall is a front side wall or a rear side wall, the side wall longitudinal direction can correspond to a luggage compartment floor transverse direction.

If the side wall is a lateral side wall, the side wall longitudinal direction can correspond to a floor element longitudinal direction.

The side wall vertical direction corresponds to a direction of extent of the respective side wall in the width, in particular a shortest connection between a base area and a floor element.

The side wall transverse direction runs orthogonally to the side wall longitudinal direction and the side wall vertical direction, and corresponds to direction of extent of the thickness of the respective side wall.

The wave crests and wave troughs of the wave shape can extend diagonally, in particular in the side wall transverse direction and side wall vertical direction, from the floor element to the base area.

The lower end of the wave troughs and wave crests, when viewed in the side element longitudinal direction, can in each case be closer to a longitudinal central plane of the side element than the upper end of the wave troughs or wave crests, respectively.

In one preferred embodiment of the luggage compartment floor according to the invention, a front side wall which is contiguous to the floor element at the front in the luggage compartment floor longitudinal direction, and/or a rear side wall which is contiguous to the floor element at the rear in the luggage compartment floor longitudinal direction, have/has at least in part a wave shape.

In an exemplary embodiment of the luggage compartment floor according to the invention, the at least one side wall, which at least in part has a wave shape, is designed to be planar in at least one region, in particular in a region which is central in the side wall longitudinal direction. The side wall in the region, in particular in the central region, is thus free of a wave shape, wherein the contiguous region(s), in particular the outer regions in the side wall longitudinal direction, have a wave shape.

In a preferred embodiment of the luggage compartment floor according to the invention, the at least one side wall, which at least in part has a wave shape, is designed to be mirror-symmetrical, in particular in relation to a side wall transverse central plane.

The side wall transverse central plane extends in the side wall transverse direction and side wall vertical direction.

In one exemplary embodiment of the luggage compartment floor according to the invention, the wave amplitudes of the individual waves of the wave shape differ at least in part, in particular completely.

In one preferred embodiment of the luggage compartment floor according to the invention, the wave amplitude of the individual waves of the wave shape decreases in the side wall longitudinal direction from one longitudinal end of the side wall, i.e. one end of the side wall in the side wall longitudinal direction, in the direction of the center of the side wall. The waves close to the center of the side wall thus have a smaller wave amplitude than the waves close to the longitudinal end.

In one exemplary embodiment, the luggage compartment floor according to the invention comprises at least one reinforcement rib.

The reinforcement rib can extend from the convexity to the base area.

The reinforcement rib can connect the convexity to the base area.

The reinforcement rib is designed to be concave, for example. In this way, the reinforcement rib forms a smooth run-out of the convexity toward the base area.

The reinforcement rib can have the shape of a crow's foot.

The reinforcement rib can extend from one side wall to the base area.

The reinforcement rib thickens in the direction of the base area, for example.

In one preferred embodiment of the luggage compartment floor according to the invention, the reinforcement rib extends from an edge on which adjacent side walls bear on one another to the base area.

The reinforcement rib can connect the edge and the base area to one another.

In one preferred embodiment, the luggage compartment floor according to the invention comprises at least four reinforcement ribs.

For example, the four reinforcement ribs extend from the edges of the side walls on which the latter are in each case contiguous to adjacent side walls to the base area.

The invention is explained in more detail hereunder by means of an exemplary embodiment illustrated in the drawing in which:

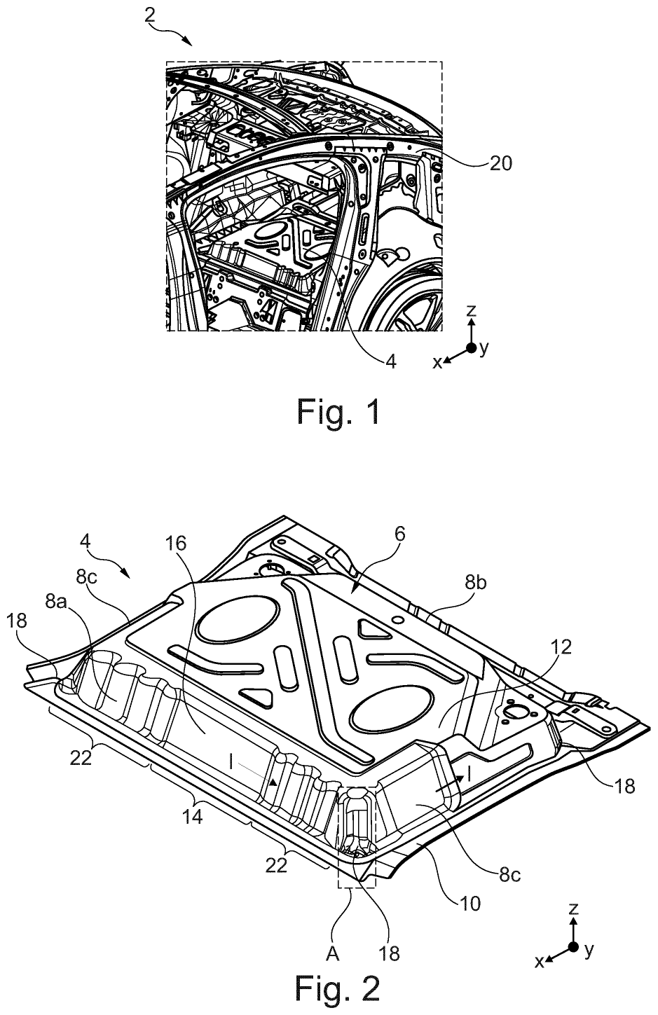

FIG. 1 shows a perspective view of a sub-region of a motor vehicle, comprising a luggage compartment floor according to the invention;

FIG. 2 shows a perspective view of the luggage compartment floor from FIG. 1 in a stand-alone illustration;

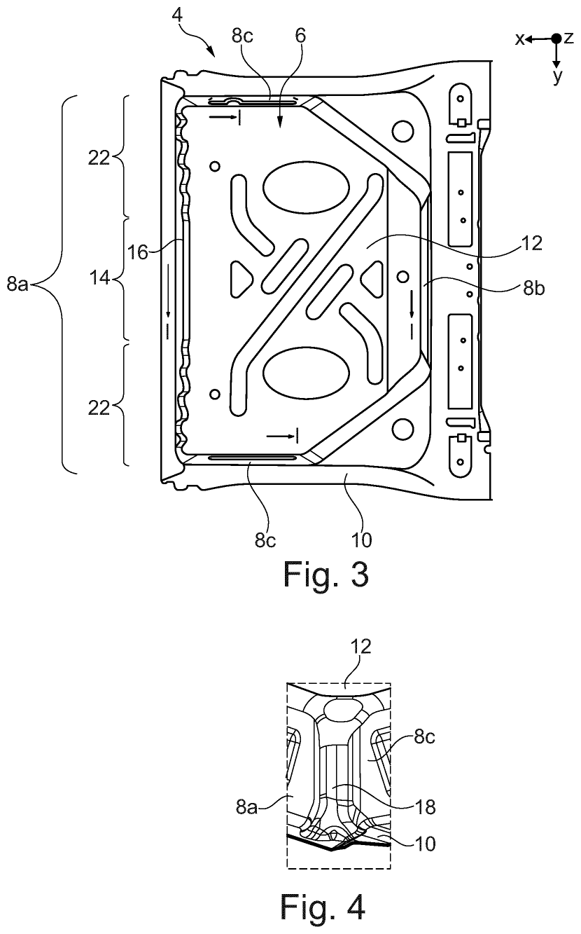

FIG. 3 shows a plan view of the luggage compartment floor from FIG. 1 in a stand-alone illustration, without any illustration of reinforcement ribs; and

FIG. 4 shows a detailed view of the region A from FIG. 2.

Illustrated in FIG. 1 is a motor vehicle 2 having a body 20 and a luggage compartment floor 4 according to the invention.

The luggage compartment floor 4 is fastened to the body 20 and covers an opening of the body 4. As can be seen from FIG. 1, the luggage compartment floor 4 is a luggage compartment floor which is at the front in the motor vehicle longitudinal direction.

In an installed state of the luggage compartment floor 4 according to the intended function in the motor vehicle 2, the luggage compartment floor longitudinal direction (x) corresponds to the motor vehicle longitudinal direction; the luggage compartment floor transverse direction (y) corresponds to the motor vehicle transverse direction; and the luggage compartment floor vertical direction (z) corresponds to the motor vehicle vertical direction.

FIGS. 2 and 3 show the luggage compartment floor 4 in a stand-alone illustration.

The luggage compartment floor 4 is formed from steel and comprises a convexity 6 which circumferentially transitions into a base area 10. The convexity 6 has a floor element 12, which extends substantially horizontally, a front side wall 8a, a rear side wall 8b, and two lateral side walls 8c which are circumferentially contiguous to the floor element 12.

The front side wall 8a is disposed on an edge of the floor element 12 that is at the front in the luggage compartment floor longitudinal direction (x). The rear side wall 8b in the luggage compartment floor longitudinal direction (x) is contiguous to the floor element 12 at the rear. The lateral side walls 8c are positioned laterally of the floor element 12 in the luggage compartment floor transverse direction (y).

As can be seen in particular from FIGS. 2 and 3, the convexity 6 is designed to be almost in the shape of a truncated pyramid. The two corners of the truncated pyramid which are at the rear in the luggage compartment floor longitudinal direction (x) and at the top in the luggage compartment floor vertical direction (z), i.e. the floor element 12 which forms the cover area of the truncated pyramid, are slightly recessed toward the bottom in the luggage compartment floor vertical direction (z).

The front side wall 8a comprises a region 14 which is central in the side wall longitudinal direction 1, lateral end regions 22 being contiguous thereto. The central region 14 is designed to be planar, i.e. flat. The lateral end regions 22 have in each case a wave shape. An amplitude of the waves of the wave shape decreases in the direction of a center 16 lying in the side wall longitudinal direction 1, or in the direction of the central region 14 of the front side wall 8a, respectively. The wave shape thus continuously runs out in the direction of the center 16.

The front side wall 8a is designed to be mirror-symmetrical in relation to a luggage compartment floor longitudinal central plane which extends in the luggage compartment floor longitudinal direction (x) and luggage compartment floor vertical direction (z). The luggage compartment floor longitudinal central plane corresponds to a side wall longitudinal central plane in the case of the front side wall 8a and the rear side wall 8b.

It is likewise conceivable that, alternatively or additionally to the wave shape of the front side wall 8a, the rear side wall 8b and/or at least one, in particular both, lateral side walls 8c have a wave shape. The wave shape(s) of the rear side wall 8b and/or the wave shape of the lateral side wall/side walls can differ from the wave shape of the front side wall 8a described above.

As can be seen in particular from FIG. 4, the convexity 6, in particular the floor element 12, is connected to the base area 10 by way of the reinforcement ribs 18. The reinforcement ribs 18 start at the edges on which the front side wall 8a, or the rear side wall 8b, bear on the lateral side walls 8c, respectively, and extend continuously in a concave manner toward the base area 10. The reinforcement ribs 18 are designed in the manner of a crow's foot. The reinforcement ribs 18 in an end region that faces the base area 10 thus split into two extensions.

It is likewise conceivable that the reinforcement ribs 18 split into more than two extensions.

### List of Reference Signs

2 Motor vehicle
4 Luggage compartment floor
6 Convexity
8a Front side wall
8b Rear side wall
8c Lateral side wall
10 Base area
12 Floor element
14 Central region
16 Center
18 Reinforcement rib
20 Body
22 End region
l Side wall longitudinal direction
x Luggage compartment floor longitudinal direction
y Luggage compartment floor transverse direction
Z Luggage compartment floor vertical direction

1-10. (canceled)

11. A luggage compartment floor for a motor vehicle, comprising:
a convexity, wherein the convexity has at least one side wall, and the at least one side wall at least in part has a wave shape.

12. The luggage compartment floor according to claim 11, wherein the least one side wall on an end side are contiguous to a base area.

13. The luggage compartment floor according to claim 11, wherein the convexity comprises a floor element, and the at least one side wall on an end side is contiguous thereto.

14. The luggage compartment floor according to claim 11, wherein a first of the at least one side wall which is at a front in the luggage compartment floor longitudinal direction (x), and/or a second of the at least one side wall which is at a rear in the luggage compartment floor longitudinal direction (x) have/has at least in part a wave shape.

15. The luggage compartment floor according to claim 14, wherein the at least one side wall, which at least in part has the wave shape, is planar in a region which is central in a longitudinal direction of the side wall.

16. The luggage compartment floor according to claim 15, wherein the at least one side wall, which at least in part has the wave shape, is mirror-symmetrical.

17. The luggage compartment floor according to claim 16, wherein wave amplitudes of individual waves of the wave shape differ at least in part.

18. The luggage compartment floor according to claim 16, wherein a wave amplitude of individual waves of the wave shape decrease in a longitudinal direction of the side wall from one longitudinal end of the at least one side wall in a direction of a center of the at least one side wall.

19. The luggage compartment floor according to claim 12, further comprising: at least one reinforcement rib which extends from the convexity to the base area.

20. The luggage compartment floor according to claim 19, wherein the reinforcement rib extends from an edge on which adjacent side walls of the at least one side wall bear on one another to the base area.
